(19) United States
(12) Patent Application Publication
(10) Pub. No.: US 2024/0069287 A1
(43) Pub. Date: Feb. 29, 2024

(54) NOVEL DESIGN FOR FIBER ARRAY UNIT (FAU) FOR OPTICAL TRANSCEIVER PRODUCTS

(71) Applicant: Intel Corporation, Santa Clara, CA (US)

(72) Inventors: Vinod ADIVARAHAN, Chandler, AZ (US); Liqiang CUI, Shenzhen, Guangdong (CN); Aditi MALLIK, Cupertino, CA (US); Boping XIE, San Ramon, CA (US); Sunil PRIYADARSHI, Sunnyvale, CA (US)

(21) Appl. No.: 18/271,791

(22) PCT Filed: Feb. 26, 2021
(86) PCT No.: PCT/CN2021/078122

§ 371 Date: Jul. 11, 2023

(51) Int. Cl. G02B 6/36

(52) U.S. Cl. CPC G02B 6/3636

(57) ABSTRACT

A fiber array unit (200) and a photonics system (890), a fiber array unit (200) comprises a substrate (205) with a first el end and a second end. A first mesa (207) is adjacent to the first end and a second mesa (209) is adjacent to the second end. A v-groove (211) is in the first mesa (207) and a slot (213) is in the second mesa (209). The v-groove (211) is aligned with the slot (213).

### TECHNICAL FIELD

Embodiments of the present disclosure relate to electronic packages, and more particularly to fiber array units (FAUs) for optical transceiver architectures.

### BACKGROUND

The microelectronic industry has begun using optical connections as a way to increase bandwidth and performance. The optical fiber is connected to the photonics die by a v-groove on the photonics die. The optical fiber is then routed to a fiber array unit (FAU). The FAU includes a v-groove for receiving the optical fiber with cladding. After the FAU v-groove, the optical fiber extends over a recessed surface of the FAU. An epoxy is then provided over the optical fiber.

However, such architectures are prone to optical fiber cracking due to bending that may happen during the fiber routing and/or during reliability testing of the transceiver module. Current designs rely on a soft epoxy and external support designs to relieve the strain on the optical fiber. This design does not sufficiently control fiber bend within the FAU that could happen during fiber routing or potential mishandling of the fiber by the operator. Additionally, the fiber inside the FAU can get stressed further during reliability testing, which may lead to fiber cracking.

### BRIEF DESCRIPTION OF THE DRAWINGS

FIG. 1 is a perspective view illustration of a fiber array unit (FAU) with a single mesa, in accordance with an embodiment.

FIG. 2A is a perspective view illustration of an FAU with a first mesa with a v-groove and a second mesa with a slot for receiving an optical fiber, in accordance with an embodiment.

FIG. 2B is a perspective view illustration of the FAU in FIG. 2A with an optical fiber and a lid, in accordance with an embodiment.

FIG. 3 is a perspective view illustration of an FAU with a v-groove that terminates at a slot with an optical fiber in the v-groove and the slot, in accordance with an embodiment.

FIG. 4A is a plan view illustration of an FAU with a first mesa with a v-groove and a second mesa with a slot, in accordance with an embodiment.

FIG. 4B is a cross-sectional illustration of the FAU in FIG. 4A along line B-B′ that illustrates the epoxy that embeds the optical fiber, in accordance with an embodiment.

FIG. 4C is a cross-sectional illustration of the FAU in FIG. 4A along line C-C′ that illustrates the optical fiber in the slot, in accordance with an embodiment.

FIG. 5 is a plan view illustration of an FAU with an epoxy that extends past the FAU substrate and forms a cone around a portion of the optical fiber, in accordance with an embodiment.

FIG. 6 is a plan view illustration of an FAU with a plurality of optical fibers passing through v-grooves and slots, in accordance with an embodiment.

FIG. 7 is a graph illustrating the stress reductions in the FAU that are attributable to the slot configuration, in accordance with an embodiment.

FIG. 8 is a cross-sectional illustration of a photonics system that comprises an FAU with a first mesa with a v-groove and a second mesa with a slot, in accordance with an embodiment.

FIG. 9 is a schematic of a computing device built in accordance with an embodiment.

### EMBODIMENTS OF THE PRESENT DISCLOSURE

Described herein are fiber array units (FAUs) for optical transceiver architectures, in accordance with various embodiments. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

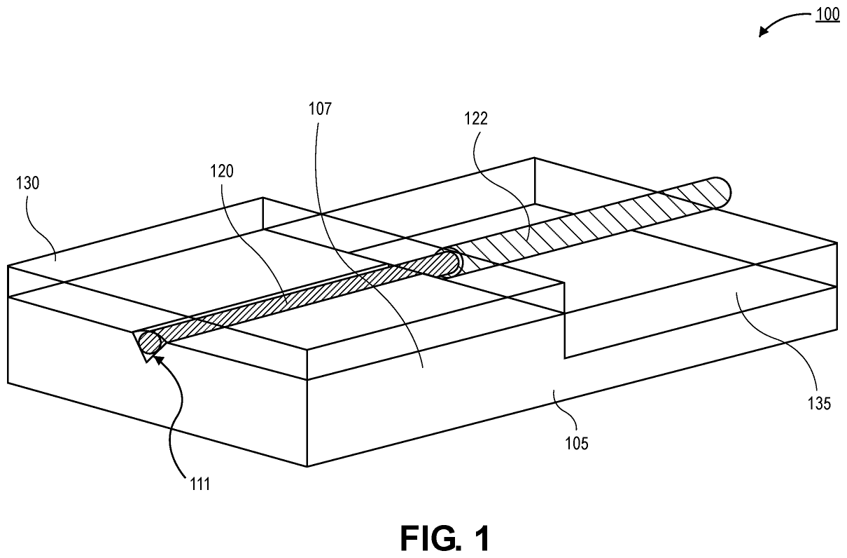

As noted above, current fiber array unit (FAU) configurations are susceptible to damage and failure due to high strains that are placed on the optical fiber. As shown in FIG. 1, an FAU may comprise a substrate 105 and a first mesa 107. A v-groove 111 is provided in the first mesa 107 for receiving an optical fiber 120. A lid 130 may secure the optical fiber 120 in the v-groove 111. After the v-groove 111 the optical fiber 120 may be coated with a coating 122. The portion of the optical fiber 120 with the coating 122 is secured in place by an epoxy 135. To improve reliability, the epoxy 135 is a soft epoxy that allows for strain in the optical fiber 120 to be absorbed. However, the strain in the optical fiber 120 easily exceeds reliability limits due to bending of the fiber within the FAU as a result of fiber handling during assembly and/or during thermal cycling. Accordingly, cracking of the optical fiber 120 within the epoxy 135 is a common mode of failure in photonics systems.

Accordingly, embodiments disclosed herein include FAU architectures that minimize the generation of strain in the fiber within the FAU. For example, strain is reduced by providing a second mesa. The second mesa may comprise a slot through which the fiber passes. The slot confines the fiber and prevents bending of the fiber within the FAU. As such, the strain on the fiber is reduced and improved reliability is obtained. In an embodiment, the fiber may also be embedded within a soft epoxy in order to further absorb the strain. In a particular embodiment, a cone of the soft epoxy may extend out past an end of the FAU substrate to even further reduce the strain on the optical fiber. Embodiments disclosed herein include FAUs with a single optical fiber, and FAUs that are configured to receive a plurality of optical fibers.

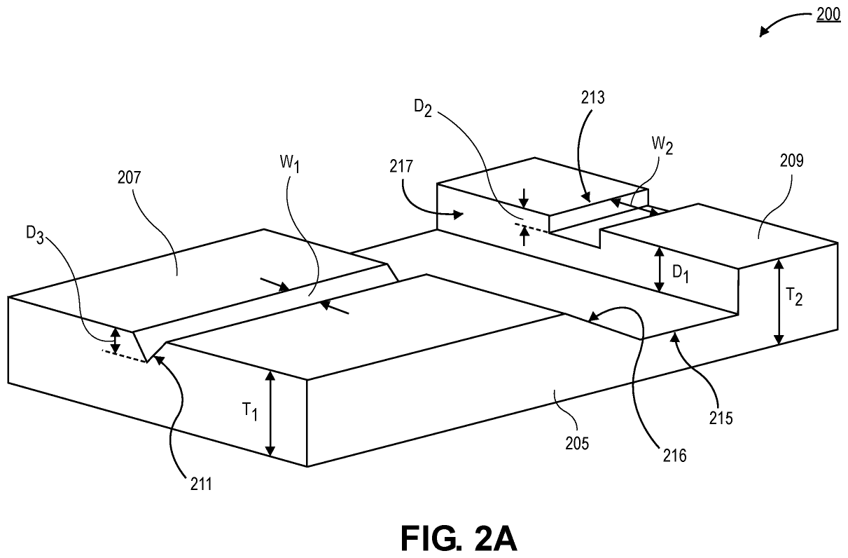

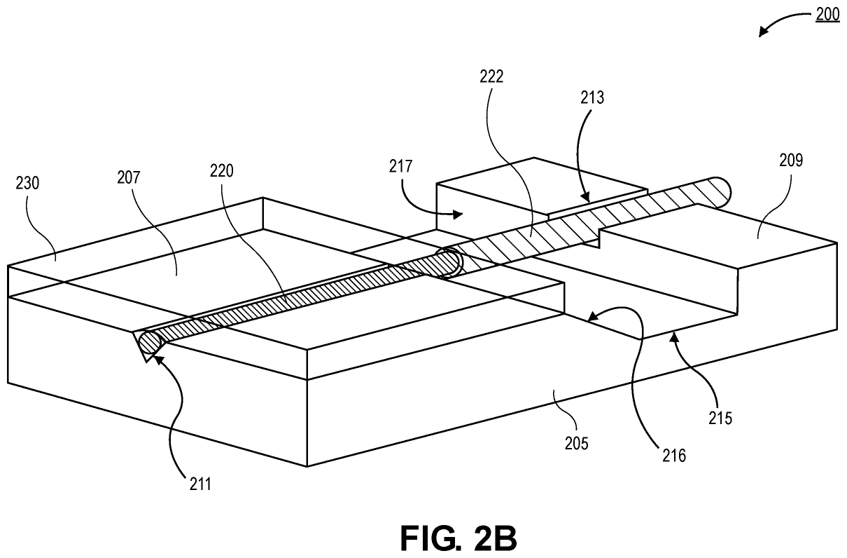

Referring now to FIG. 2A, a perspective view illustration of an FAU 200 is shown, in accordance with an embodiment. In an embodiment, the FAU 200 may comprise a base substrate 205. The base substrate 205 may be glass or any other rigid material, such as some plastics, and the like. In an embodiment, the FAU 200 may comprise a first mesa 207 and a second mesa 209. The first mesa 207 may be provided adjacent to a first end of the substrate 205 and the second mesa 209 may be provided adjacent to a second end of the substrate 205 that is opposite to the first end of the substrate 205. In an embodiment, the first mesa 207 may have a first thickness T₁, and the second mesa 209 may have a second thickness T₂. In an embodiment, the first thickness T₁ may be substantially similar to the second thickness T₂. In other embodiments, the first thickness T₁ may be different than the second thickness T₂. The first mesa 207 and the second mesa 209 may comprise the same material as the substrate 205. For example, the substrate 205, the first mesa 207, and the second mesa 209 may be a single monolithic structure in some embodiments.

In an embodiment, a v-groove 211 is provided into the first mesa 207. The v-groove 211 may extend across an entire width of the first mesa 207. As is typical in photonics architectures, the v-groove 211 may have sidewalls that are angled towards each other. In the illustrated embodiment, the sidewalls continue until they reach each other to provide a point at the bottom of the v-groove 211. In other embodiments, the sidewalls may terminate at a flat bottom surface, to form a trapezoidal v-groove 211.

In an embodiment, a slot 213 is provided into the second mesa 209. The slot 213 may extend across an entire width of the second mesa 209. In an embodiment, the slot 213 may have substantially vertical sidewalls. However, in other embodiments the sidewalls may be angled. The slot 213 may have a substantially planar bottom surface. In an embodiment, the slot 213 is aligned with the v-groove 211. Being aligned with each other may include an alignment sufficient to allow for a single optical fiber (not shown in FIG. 2A) to sit in both the v-groove 211 and the slot 213. In a particular embodiment, a centerline of the slot 213 is substantially aligned with a centerline of the v-groove 211.

In an embodiment, a maximum width W₁ of the v-groove 211 is smaller than a width W₂ of the slot 213. The difference in the widths W₁ and W₂ account for which portion of the fiber is being accommodated. For example, the v-groove 211 houses an optical fiber with a cladding, and the slot 213 houses an optical fiber with a cladding and a coating. As such, the slot 213 needs to be larger than the v-groove 211. Additionally, the side W₂ of the slot 213 may be larger than an outer diameter of the fiber and coating in order to allow an epoxy to surround a perimeter of the coating within the slot 213.

In an embodiment, the first mesa 207 may be separated from the second mesa 209 by a recess 215. The recess 215 may comprise a first wall 216 at the first mesa 207 and a second wall 217 at the second mesa 209. In an embodiment, the first wall 216 may be an angled wall, as shown in FIG. 2A. In FIG. 2A, the first wall 216 is angled away from the first mesa 207. However, it is to be appreciated that the first wall 216 may be substantially vertical in some embodiments. In an embodiment, the second wall 217 may be substantially vertical, as shown in FIG. 2A. However, it is to be appreciated that the second wall 217 may be angled in some embodiments. For example, the second wall 217 may be angled away from the second mesa 209.

In an embodiment, the depth D₁ of the recess 215 is greater than a depth D2 of the slot 213. In other embodiments, the depth D₁ may be substantially equal to the depth D2. In an embodiment, a depth D3 of the v-groove 211 may also be smaller than the depth D₁ of the recess 215. The recess 215 may provide a volume where excess epoxy material may be stored (as will be described in greater detail below). The recess 215 may extend across an entire width of the FAU 200. That is, the recess 215 may completely separate the first mesa 207 from the second mesa 209.

Referring now to FIG. 2B, a perspective view illustration of an FAU 200 with an optical fiber 220 is shown, in accordance with an embodiment. In an embodiment, the optical fiber 220 may comprise a glass fiber. The optical fiber 220 may comprise a cladding in some embodiments. The optical fiber 220 may be any type of fiber such as a single mode optical fiber or a multi-mode optical fiber. In an embodiment, a first portion of the optical fiber 220 is uncoated and a second portion of the optical fiber 220 is coated with a coating 222. The coating 222 may be a polymeric coating or any other suitable coating for optical fibers.

In an embodiment, the uncoated portion of the optical fiber 220 may be inserted into the v-groove 211 in the first mesa 207. The optical fiber 220 may rest on the sidewall surfaces of the v-groove 211. In an embodiment, the optical fiber 220 is pushed down against the v-groove 211 by a lid 230. The lid 230 is shown clear in FIG. 2B for clarity, but it is to be appreciated that the lid 230 may be opaque in some embodiments. The lid 230 may substantially cover the first mesa 207. In some embodiments, the lid 230 may have an edge that is substantially aligned with the first sidewall 216 of the recess 215.

In an embodiment, the optical fiber 220 exits the v-groove 211 over the recess 215, and the coating 222 is started over the recess 215. The coated fiber 222 then extends through the slot 213 in the second mesa 209. In an embodiment, the slot 213 has dimensions that are larger than that of the coated fiber 222. For example, a width of the slot 213 and a depth of the slot 213 may be greater than an outer diameter of the coated fiber 222. In some embodiments, the coated fiber 222 does not contact surfaces of the slot 213. Instead, an epoxy material (not shown in FIG. 2B for clarity) may be between the coated fiber 222 and the surfaces of the slot 213. Though in some embodiments, the coated fiber 222 may contact a bottom surface of the slot 213. Despite not contacting the slot 213, the slot functions to restrict bending of the coated fiber 222 within the FAU and reduces the strain and improves reliability. In an embodiment, the epoxy fills the recess 215 and the portions of the slot 213 not occupied by the coated fiber 222.

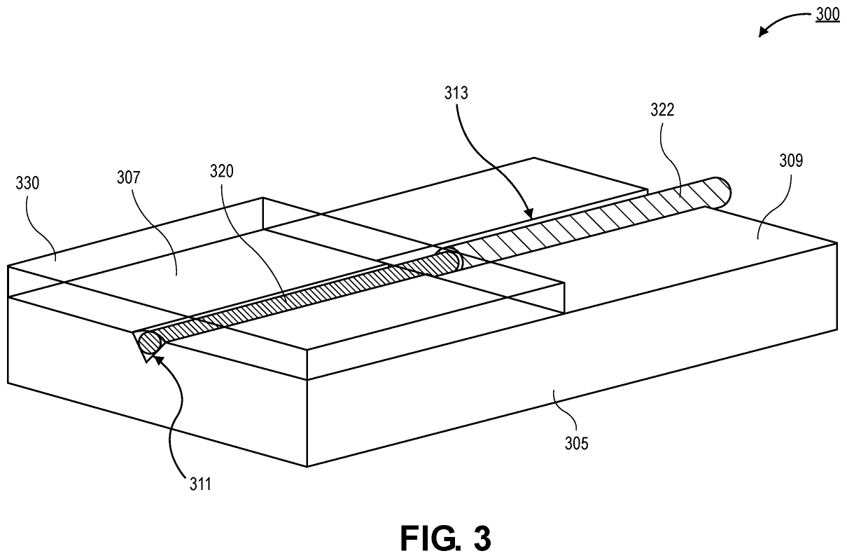

Referring now to FIG. 3, a perspective view illustration of an FAU 300 is shown, in accordance with an additional embodiment. In an embodiment, the FAU 300 comprises a substrate 305. The substrate 305 may comprise a first mesa 307 and a second mesa 309. The first mesa 307 may be the portion of the substrate 305 that comprises a v-groove 311, and the second mesa 309 may be the portion of the substrate 305 that comprises a slot 313. The first mesa 307 and the second mesa 309 may directly contact each other to form a single monolithic mesa. This is different from the embodiments described above with respect to FIGS. 2A and 2B, where the first mesa 207 is separated from the second mesa 209 by a recess 215.

Due to the first mesa 307 being immediately adjacent to the second mesa 309, the v-groove 311 terminates directly at the beginning of the slot 313. As such, a portion of the uncoated fiber 320 may also be positioned within the slot 313. This is in contrast to the embodiments described above where only the coated fiber 222 is provided in the slot 213 as shown in FIG. 2b. In an embodiment, an epoxy may be provided over the second mesa 309 and over the coated fiber 322 and the uncoated fiber 320 within the slot 313.

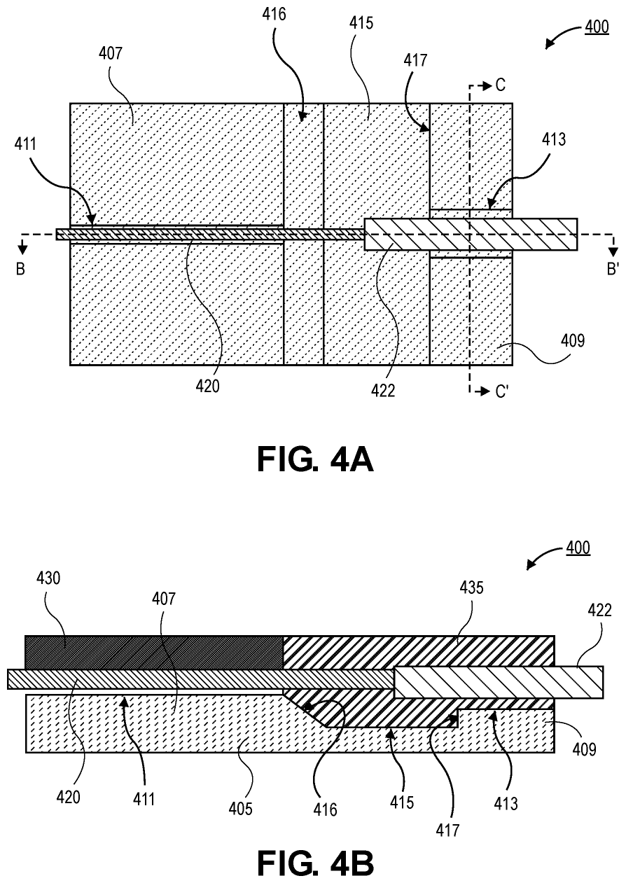

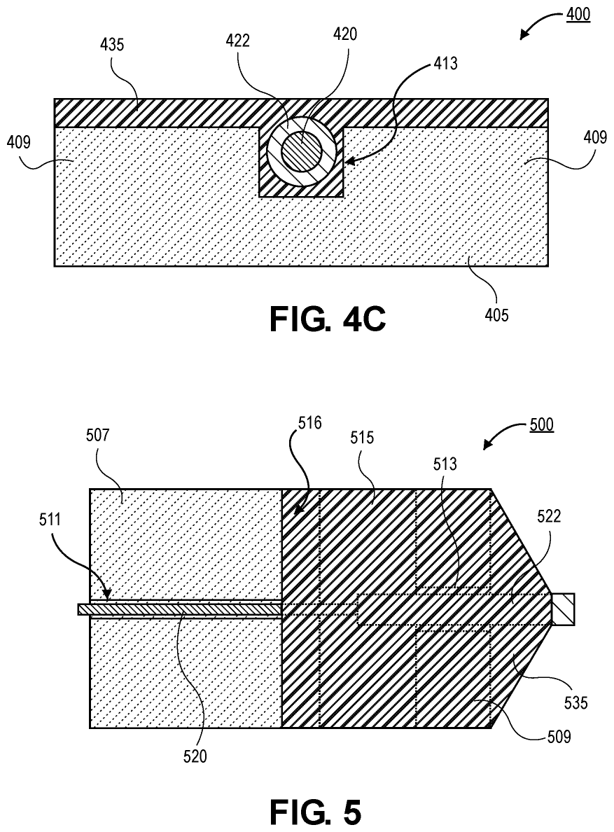

Referring now to FIG. 4A, a plan view illustration of an FAU 400 is shown, in accordance with an embodiment. In FIG. 4A, the fiber lid and the epoxy are omitted in order to not obscure the underlying features of the FAU 400. The FAU 400 may comprise a first mesa 407 and a second mesa 409. The first mesa 407 may be separated from the second mesa 409 by a recess 415. The recess 415 may include a sloped sidewall 416 adjacent to the first mesa 407 and a vertical sidewall 417 adjacent to the second mesa 409. Though it is to be appreciated that the sidewalls 416 and 417 of the recess 415 may be sloped or vertical in accordance with additional embodiments.

In an embodiment, a v-groove 411 extends across the first mesa 407. Additionally, a slot 413 extends across the second mesa 409. A width of the v-groove 411 may be smaller than a width of the slot 413. The difference in the widths allows for the wider coated portion 422 of the optical fiber 420 to be accommodated by the slot 413. In an embodiment, the coated fiber 422 may be within the slot 413, but is separated from the surfaces of the slot 413 by an epoxy (not shown). In an embodiment, the optical fiber 420 (e.g., an optical fiber with a cladding) is supported by the v-groove 411. The optical fiber 420 may directly contact the surfaces of the v-groove 411.

In an embodiment the optical fiber 420 and the coated fiber 422 span across the recess 415. That is, the portion of the optical fiber 420 over the recess 415 may not be supported from below directly by the recessed surface 415. Instead, an epoxy (not shown) will surround a perimeter of the coated fiber 422 and the optical fiber 420.

Referring now to FIG. 4B, a cross-sectional illustration of the FAU in FIG. 4A along line B-B′ is shown, in accordance with an embodiment. In an embodiment, the FAU comprises a substrate 405 with a first mesa 407 and a second mesa 409. A recess 415 may separate the first mesa 407 from the second mesa 409. The recess may have a first sidewall 416 and a second sidewall 417. A v-groove 411 is provided in the first mesa 407, and a slot 413 is provided in the second mesa 409.

As shown, the optical fiber 420 may not be supported by the bottom of the v-groove 411. Instead, the optical fiber 420 may be supported by sidewalls of the v-groove 411 (out of the plane of FIG. 4B). In an embodiment, a lid 430 may press down against the optical fiber 420 to secure the optical fiber 420 in the v-groove 411. In an embodiment, the coated fiber 422 may be supported by an epoxy 435 in the slot 413. In other embodiments, the coated fiber 422 may be supported directly by a bottom surface of the slot 413.

In an embodiment, the optical fiber 420 and the portion of the coated fiber 422 span across the cavity 415 between the v-groove 411 and the slot 413. In an embodiment, an epoxy 435 may fill portions of the cavity 415 that are not occupied by the optical fiber 420 or the portion of the coated fiber 422. The epoxy 435 may be a soft epoxy that allows for strain reduction in the optical fiber 420. Particularly, the stresses in the fiber are at the highest at the junction between the optical fiber 420 and the portion of the coated fiber 422. As such, the presence of the soft epoxy 435 at this junction helps to minimize the stress in the optical fiber 420 and improves reliability. Additionally, stress is reduced in part by the slot 413 which prevents or limits bending of the optical fiber 420 within the FAU 400.

Referring now to FIG. 4C, a cross-sectional illustration of the FAU 400 in FIG. 4A along line C-C′ is shown, in accordance with an embodiment. As shown, the substrate 405 includes a second mesa 409. A slot 413 is formed into the second mesa 409, and the optical fiber 420 with the coating 422 sits in the slot 413. As shown, the coating 422 is entirely surrounded by the epoxy 435. However, in some embodiments a bottom surface of the coating 422 may rest on the bottom surface of the slot 413. In an embodiment, the sidewalls of the slot 413 are separated from the coating 422 by portions of the epoxy 435. Separating the coating 422 from the sidewalls of the slot 413 allows for improved strain reduction in the FAU 400.

Referring now to FIG. 5, a plan view illustration of an FAU 500 is shown, in accordance with an embodiment. In FIG. 5, the plate over the v-groove 511 is omitted for clarity. As such, the first mesa 507 and the optical fiber 520 sitting in the v-groove 511 are visible. The features below the epoxy 535 are illustrated in dashed lines. For example, the cavity 515, the sidewall 516 of the cavity 515, the second mesa 509, and the slot 513 are illustrated with dashed lines to indicate that they are below the epoxy 535. Additionally, a portion of the optical fiber 520 and the coated portion 522 of the optical fiber are also shown with dashed lines.

As shown in FIG. 5, the epoxy 535 extends past an edge of the second mesa 509 and surrounds the coated portion 522 of the optical fiber as it extends past the edge of the second mesa 509. In a particular embodiment, the excess epoxy 535 may have a cone shape around the coated portion 522 of the optical fiber. The presence of the additional epoxy 535 in a cone shape further helps to minimize strain in the optical fiber that may result from bending or thermal cycling. As such, the presence of the cone of epoxy 535 may improve reliability of the device.

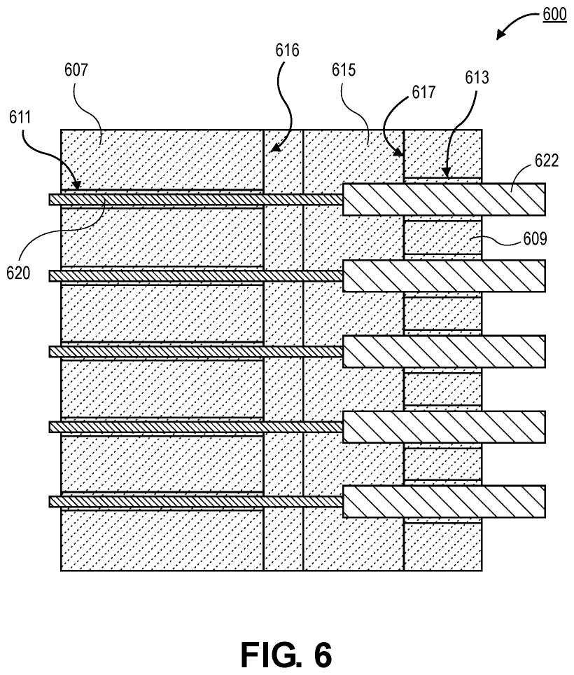

Referring now to FIG. 6, a plan view illustration of an FAU 600 is shown, in accordance with an additional embodiment. In an embodiment, the FAU 600 may comprise a first mesa 607 and a second mesa 609. The first mesa 607 may be separated from the second mesa 609 by a recess 615. Also shown in the plan view is a sidewall 616 of the recess 615 that is sloped. Due to the slope, the sidewall 616 is visible in the plan view illustration. The opposite sidewall 617 of the recess 615 is not visible since it is a vertical sidewall.

In contrast to the embodiments described above, the FAU 600 is configured to accommodate a plurality of optical fibers 620 and coated fibers 622. For example, five optical fibers 620 (with coated portions 622) are set into the FAU 600. While five optical fibers 620 are shown, it is to be appreciated that the FAU 600 may accommodate any number of optical fibers 620.

In an embodiment, the first mesa 607 may comprise a plurality of v-grooves 611 for accommodating the plurality of optical fibers 620. The v-grooves 611 may be provided in a row with the v-grooves 611 being substantially parallel to each other. The v-grooves 611 may extend entirely across the first mesa 607. In an embodiment, the second mesa 609 may comprise a plurality of slots 613 for accommodating the plurality of coated fibers 622. The slots 613 may be provided in a row with the slots 613 being substantially parallel to each other. Each of the slots 613 may be aligned with different ones of the v-grooves 611, and the optical fibers 620 may span across the recess 615. The boundary between the optical fibers 620 and the coated fibers 622 may be provided over the recess 615.

In the illustrated embodiment, the plate over the first mesa 607 is omitted for clarity. However, it is to be appreciated that a plate may be used to press down the optical fibers 620 into the v-grooves 611. Similarly, the epoxy over the recess 615 and the second mesa 609 is omitted for clarity. However, it is to be appreciated that a soft epoxy may be disposed over the optical fibers 620 and the coated fibers 622 similar to embodiments described above. In an embodiment, the epoxy may also comprise a cone shaped region around portions of the coated fibers 622 that extend out from the edge of the second mesa 609. In an embodiment, each of the plurality of coated fibers 622 may comprise separate cones of epoxy.

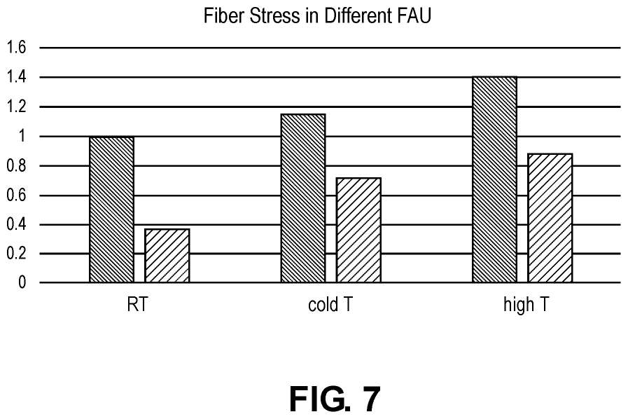

Referring now to FIG. 7, a graph depicting the difference in the normalized stress of an optical fiber in the FAU for different architectures and conditions is shown, in accordance with an embodiment. For each condition (e.g., room temperature (RT), cold temperature (cold T), and high temperature (high T)), the bar on the left is a traditional FAU (e.g., similar to the embodiment shown in FIG. 1) without a second mesa and a slot, and the bar on the right is an FAU with a second mesa and a slot in accordance with embodiments disclosed herein. For each of the conditions, the normalized stress for embodiments with a second mesa and a slot is lower than the standard FAU. As shown, an approximately 30% stress reduction or better may be provided in embodiments with a second mesa and a slot compared to the stress in the standard FAU.

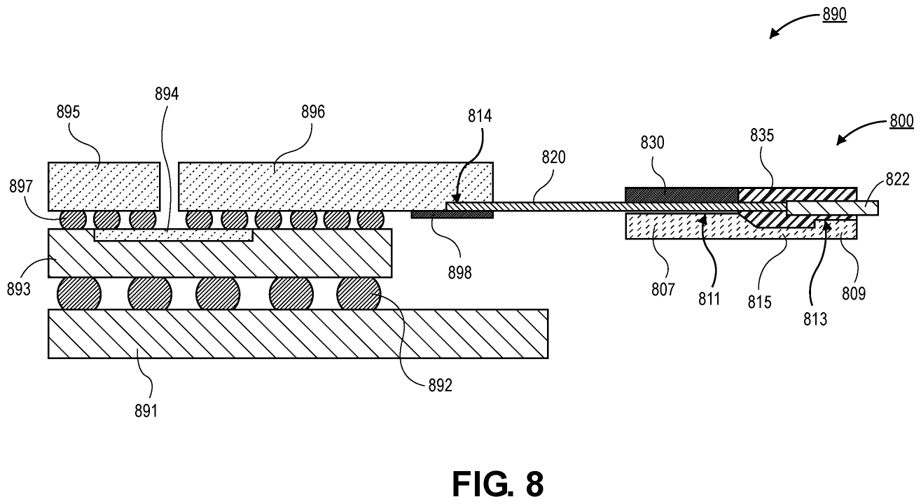

Referring now to FIG. 8, a cross-sectional illustration of a photonics system 890 is shown, in accordance with an embodiment. In an embodiment, the photonics system 890 may comprise a board 891. The board 891 may be a printed circuit board (PCB) or the like. A package substrate 893 may be coupled to the board 891 by interconnects 892. As shown in FIG. 8, the interconnects 892 are solder balls. However, it is to be appreciated that the interconnects 892 may comprise any interconnect architecture, such as, but not limited to, socketing architectures. In an embodiment, the board 891 and the package substrate 893 may comprise conductive routing (not shown) to provide electrical connections in the photonics system 890. For example, the conductive routing may include traces, pads, vias, and the like.

In an embodiment, a processor 895 and a photonics die 896 may be coupled to the package substrate by interconnects 897. The interconnects 897 may be any suitable first level interconnect (FLI) architecture. For example, the interconnects 897 may comprise solder balls, copper bumps, or the like. In an embodiment, the processor 895 may comprise any suitable processor die. The photonics die 896 may comprise functionality for converting optical signals to electrical signals, and/or for converting electrical signals to optical signals. In an embodiment, the processor 895 may be communicatively coupled with the photonics die 896 by an embedded bridge 894 or any other high density routing architecture.

In an embodiment, the photonics die 896 may overhang an edge of the package substrate 893. The overhang may provide access to a v-groove 814 on the photonics die 896. In an embodiment, an optical fiber 820 is coupled to the v-groove 814. A lid 898 may secure the optical fiber 820 into the v-groove 814. In an embodiment, the optical fiber 820 continues to an FAU 800. In an embodiment, the fiber 820/822 exits the FAU 800 from both sides and connects to the v-groove 814. In other embodiments, the fiber 820 is polished so that it is substantially flush with an end face of the FAU 800. In such embodiments, the FAU 800 can “butt couple” to the v-groove 814 or a die edge through a bridge/bench connection.

The FAU 800 may be substantially similar to any of the FAUs described in greater detail above. For example, the FAU may comprise a first mesa 807 and a second mesa 809. The first mesa 807 may be separated from the second mesa 809 by a recess 815. In an embodiment, the optical fiber 820 is inserted into a v-groove 811 in the first mesa 807 and extends to a slot 813 in the second mesa 809. At a point across the recess 815 the fiber may be coated to form a coated fiber 822. A lid 830 secures the optical fiber 820 into the v-groove 811. An epoxy 835 may be used to secure the coated fiber 822 in the slot 813. The slot 813 and the epoxy 835 provide stress reduction to the optical fiber 820 in order to improve reliability of the photonics system 890.

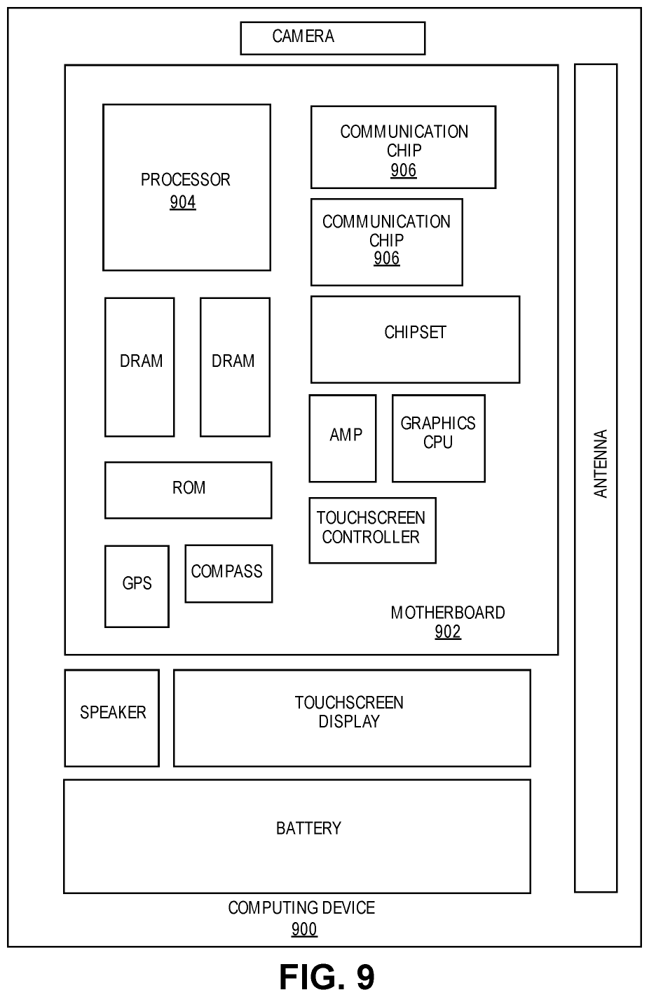

FIG. 9 illustrates a computing device 900 in accordance with one implementation of the invention. The computing device 900 houses a board 902. The board 902 may include a number of components, including but not limited to a processor 904 and at least one communication chip 906. The processor 904 is physically and electrically coupled to the board 902. In some implementations the at least one communication chip 906 is also physically and electrically coupled to the board 902. In further implementations, the communication chip 906 is part of the processor 904.

These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth).

The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing device 900 includes an integrated circuit die packaged within the processor 904. In some implementations of the invention, the integrated circuit die of the processor may be part of a photonics system that comprises an FAU with a first mesa, a second mesa, and a slot into the second mesa for accommodating a coated fiber, in accordance with embodiments described herein. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another implementation of the invention, the integrated circuit die of the communication chip may be part of a photonics system that comprises an FAU with a first mesa, a second mesa, and a slot into the second mesa for accommodating a coated fiber, in accordance with embodiments described herein.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

Example 1: a fiber array unit, comprising: a substrate with a first end and a second end; a first mesa adjacent to the first end; a second mesa adjacent to the second end; a v-groove in the first mesa; and a slot in the second mesa, wherein the v-groove is aligned with the slot.

Example 2: the fiber array unit of Example 1, further comprising: a recess into the substrate between the first mesa and the second mesa.

Example 3: the fiber array unit of Example 2, wherein the recess has a sloped sidewall adjacent to the first mesa and a vertical sidewall adjacent to the second mesa.

Example 4: the fiber array unit of Example 2 or Example 3, wherein a depth of the slot is less than a depth of the recess.

Example 5: the fiber array unit of Examples 1-4, wherein the first mesa and the second mesa are a monolithic structure.

Example 6: the fiber array unit of Example 5, wherein the slot terminates at an end of the v-groove.

Example 7: the fiber array unit of Examples 1-6, wherein a maximum width of the v-groove is smaller than a width of the slot.

Example 8: the fiber array unit of Examples 1-7, wherein the slot extends through an entire width of the second mesa.

Example 9: the fiber array unit of Examples 1-8, wherein the slot has substantially vertical sidewalls.

Example 10: the fiber array unit of Examples 1-9, wherein a thickness of the first mesa is substantially equal to a thickness of the second mesa.

Example 11: the fiber array unit of Examples 1-10 further comprising: a plurality of v-grooves in the first mesa; and a plurality of slots in the second mesa, wherein individual ones of the v-grooves are aligned with individual ones of the plurality of slots.

Example 12: a fiber array unit, comprising: a substrate; a first mesa over the substrate; a v-groove into the first mesa; a second mesa over the substrate; a slot into the second mesa, wherein the slot is aligned with the v-groove; and an optical fiber disposed in the v-groove and the slot, wherein a first end of the optical fiber in the v-groove is a cladded fiber, and wherein a second end of the optical fiber in the slot is a cladded fiber with a coating around the cladding.

Example 13: the fiber array unit of Example 12, further comprising: a plate over the first end of the optical fiber.

Example 14: the fiber array unit of Example 12 or Example 13, further comprising: an epoxy over the second end of the optical fiber.

Example 15: the fiber array unit of Examples 12-14, further comprising: a recess between the first mesa and the second mesa.

Example 16: the fiber array unit of Example 15, further comprising: an epoxy over the second end of the optical fiber, wherein the epoxy surrounds a perimeter of the optical fiber and fills the recess.

Example 17: the fiber array unit of Example 16, wherein the epoxy forms a cone around a portion of the optical fiber extending out from the slot.

Example 18: the fiber array unit of Example 15, wherein a recess has a sloped sidewall adjacent to the first mesa and a vertical sidewall adjacent to the second mesa.

Example 19: the fiber array unit of Examples 12-18, wherein a width of the slot is greater than a diameter of the optical fiber.

Example 20: the fiber array unit of Examples 12-19, wherein a depth of the slot is less than a depth of the recess.

Example 21: the fiber array unit of Examples 12-20, wherein the slot has substantially vertical sidewalls.

Example 22: the fiber array unit of Examples 12-21, wherein a thickness of the first mesa is substantially equal to a thickness of the second mesa.

Example 23: a photonics system, comprising: a board; a package substrate coupled to the board; a photonics die coupled to the package substrate, wherein the photonics die comprises a v-groove; an optical fiber, wherein a first end of the optical fiber is in the v-groove; and a fiber array unit, wherein a second end of the optical fiber passes through the fiber array unit, and wherein the fiber array unit comprises: a substrate with a first end and a second end; a first mesa adjacent to the first end; a second mesa adjacent to the second end; a v-groove in the first mesa, wherein the optical fiber sits in the v-groove; and a slot in the second mesa, wherein the v-groove is aligned with the slot, and wherein the optical fiber is positioned in the slot.

Example 24: the photonics system of Example 23, wherein a portion of the optical fiber passing through the v-groove is cladded, and wherein a portion of the optical fiber passing through the slot is cladded and coated.

Example 25: the photonics system of Example 23 or Example 24, further comprising: an epoxy over a portion of the optical fiber passing through the slot.

1. A fiber array unit, comprising:
a substrate with a first end and a second end;
a first mesa adjacent to the first end;
a second mesa adjacent to the second end;
a v-groove in the first mesa; and
a slot in the second mesa, wherein the v-groove is aligned with the slot.

2. The fiber array unit of claim 1, further comprising:
a recess into the substrate between the first mesa and the second mesa.

3. The fiber array unit of claim 2, wherein the recess has a sloped sidewall adjacent to the first mesa and a vertical sidewall adjacent to the second mesa.

4. The fiber array unit of claim 2, wherein a depth of the slot is less than a depth of the recess.

5. The fiber array unit of claim 1, wherein the first mesa and the second mesa are a monolithic structure.

6. The fiber array unit of claim 5, wherein the slot terminates at an end of the v-groove.

7. The fiber array unit of claim 1, wherein a maximum width of the v-groove is smaller than a width of the slot.

8. The fiber array unit of claim 1, wherein the slot extends through an entire width of the second mesa.

9. The fiber array unit of claim 1, wherein the slot has substantially vertical sidewalls.

10. The fiber array unit of claim 1, wherein a thickness of the first mesa is substantially equal to a thickness of the second mesa.

11. The fiber array unit of claim 1 further comprising:
a plurality of v-grooves in the first mesa; and
a plurality of slots in the second mesa, wherein individual ones of the v-grooves are aligned with individual ones of the plurality of slots.

12. A fiber array unit, comprising:
a substrate;
a first mesa over the substrate;
a v-groove into the first mesa;
a second mesa over the substrate;
a slot into the second mesa, wherein the slot is aligned with the v-groove; and
an optical fiber disposed in the v-groove and the slot, wherein a first end of the optical fiber in the v-groove is a cladded fiber, and wherein a second end of the optical fiber in the slot is a cladded fiber with a coating around the cladding.

13. The fiber array unit of claim 12, further comprising:
a plate over the first end of the optical fiber.

14. The fiber array unit of claim 12, further comprising:
an epoxy over the second end of the optical fiber.

15. The fiber array unit of claim 12, further comprising:
a recess between the first mesa and the second mesa.

16. The fiber array unit of claim 15, further comprising:
an epoxy over the second end of the optical fiber, wherein the epoxy surrounds a perimeter of the optical fiber and fills the recess.

17. The fiber array unit of claim 16, wherein the epoxy forms a cone around a portion of the optical fiber extending out from the slot.

18. The fiber array unit of claim 15, wherein a recess has a sloped sidewall adjacent to the first mesa and a vertical sidewall adjacent to the second mesa.

19. The fiber array unit of claim 12, wherein a width of the slot is greater than a diameter of the optical fiber.

20. The fiber array unit of claim 12, wherein a depth of the slot is less than a depth of the recess.

21.-25. (canceled)
